(19) United States
(12) Patent Application Publication
(10) Pub. No.: US 2011/0121715 A1
(43) Pub. Date: May 26, 2011

(54) Light Bulb Having Light Diffusion Structure

(76) Inventor: Chih-Wen Mai, Hsinchu (TW)

(21) Appl. No.: 12/626,617

(22) Filed: Nov. 26, 2009

(51) Int. Cl. H01J 5/48

(52) U.S. Cl. 313/318.11; 313/318.01

(57) ABSTRACT

A light bulb having a light diffusion structure is provided. The light bulb includes a light source, a cap, and a shell. The light source is secured to and electrically connected to the cap. The cap is adapted for connecting with a power supply for providing an electric current from the power supply to the light source for exciting the light source to emit a light. The shell is secured to the cap, and defines a space having an opening. The light source is received in the space of the shell from the opening, and the opening is sealed by the cap. A part of the shell is configured with a coarse surface, and the rest part of the shell is provided with an over coat layer.

### BACKGROUND OF THE INVENTION

1. Field of the Invention

The present invention relates generally to a light bulb having a light diffusion structure, and more particularly, to a light diffusion structure provided at a surface of a lighting bulb for diffusing a light emitted from the lighting bulb and anti-glaring.

2. The Prior Arts

A typical conventional PAR type LED bulb usually includes a reflective layer plated on an inner surface thereof Therefore, such an LED bulb has a convergent illuminating angle adapted for single direction illumination, and therefore is usually used for locally emphasizing illumination. Because of the convergent characteristics of the LED bulb and the nontransparent reflective layer, when the PAR type LED bulb is installed in a lamp shade of a picture lamp or any other home lighting lamps, a shadow will occur at an opposite side of the LED bulb in the lamp shade. The shadow generally adversely affects the appearance of the home lighting lamp, and also degrades the luminance thereof Further, the light directly emitted from the filament is very glaring, and therefore a white color film is usually coated on an inner surface of the conventional LED bulb or a conventional incandescent bulb for softening the glaring light and preventing direct irritation to eyes. However, the provision of the white film on the inner surface of the conventional bulb is only adapted for softening the light, but is incapable of improving the illumination.

### SUMMARY OF THE INVENTION

A primary objective of the present invention is to provide a light diffusion structure for solving the problem of the conventional bulb which directly outputs light from a transparent bulb and irritates user's eyes. The light diffusion structure is also adapted for strengthening the diffusion of the light emitted from the light source, thus improving the general performance of the bulb.

For achieving the foregoing and other objectives, the present invention provides a light bulb. The light bulb includes a light source, a cap, and a shell. The light source is secured to and electrically connected to the cap. The cap is adapted for connecting with a power supply for providing an electric current from the power supply to the light source for exciting the light source to emit a light. The shell is secured to the cap, and defines a space having an opening. The light source is received in the space of the shell from the opening, and the opening is sealed by the cap. A part of the shell is configured with a coarse surface, and the rest part of the shell is provided with an over coat layer.

According to the light bulb of the present invention, the coarse surface presents micro-protrusions and micro-recesses, at which the light emitted from the light source is deflected. In such a way, diffusion of the light is enforced thereby. Further the over coat layer of the shell reflects the light towards an opposite side of the over coat layer. The coarse surface and the over coat layer give the transparent shell a foggy appearance. The over coat layer is transparent in part and reflective in part. The reflectivity of the over coat layer does not generate a shadow, so that the light deflected from the coarse surface is more uniformly diffused outwardly.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a perspective view of an embodiment of the present invention;

FIG. 2 is an exploded perspective view of the embodiment of the present invention;

FIG. 3 illustrates a further embodiment of the present invention; and

FIG. 4 is a partial enlargement view of the embodiment of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

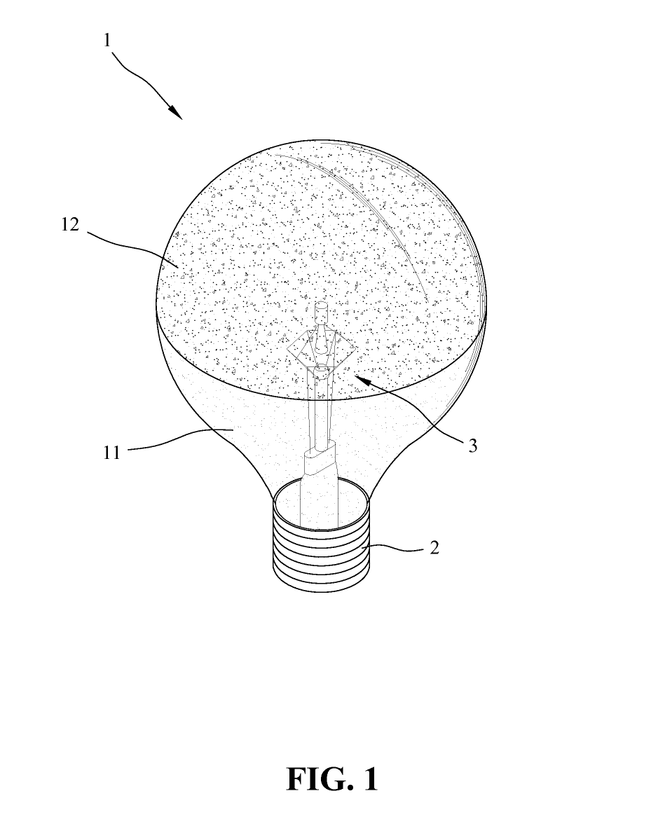

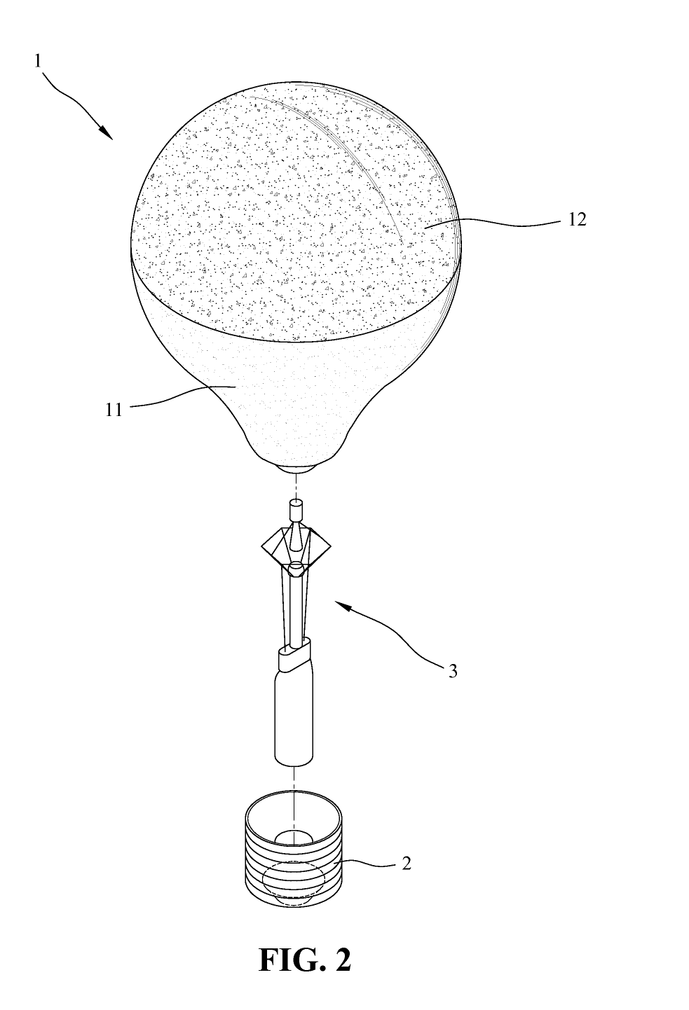

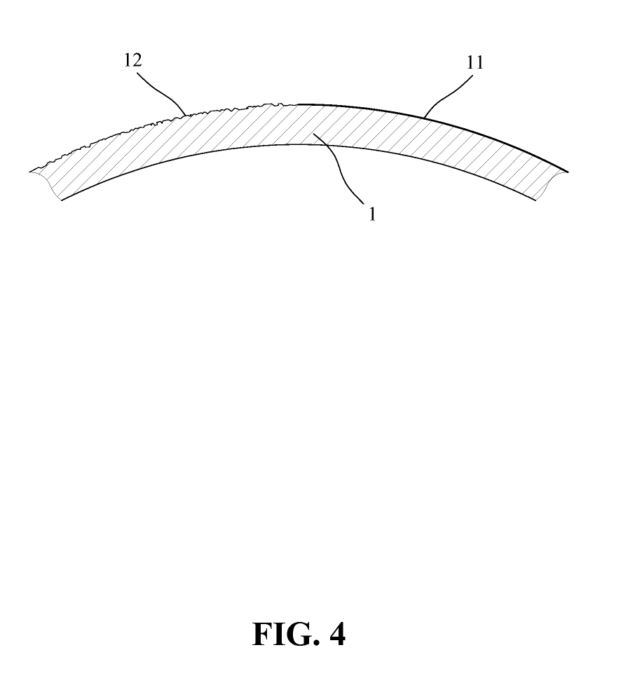

FIG. 1 is a perspective view of an embodiment of the present invention. FIG. 2 is an exploded perspective view of the embodiment of the present invention. FIG. 4 is a partial enlargement view of the embodiment of the present invention. Referring to FIGS. 1, 2, and 4, there is shown a light bulb having a light diffusion structure.

The light bulb includes a shell 1, a cap 2 and a light source 3. The light source 3 is secured to and electrically connected to the cap 2. The cap 2 is adapted for connecting with a power supply (not shown in the drawings) for providing an electric current from the power supply to the light source 3 for exciting the light source 3 to emit a light. The shell 1 is secured to the cap 2, and defines a space having an opening. The light source 3 is received in the space of the shell 1 from the opening, and the opening is sealed by the cap 2. A part of the shell 1 is configured with a coarse surface 12, and the rest part of the shell 1 is provided with an over coat layer 11.

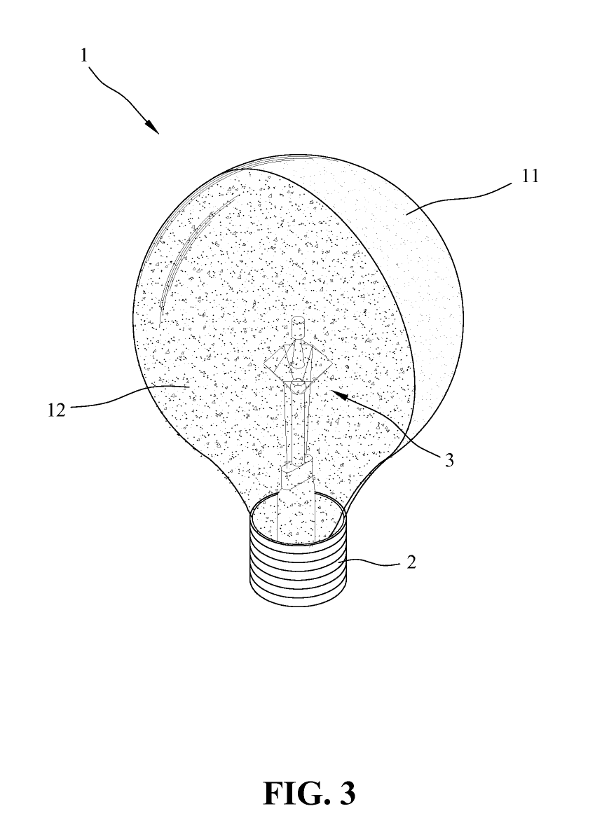

Preferably, the light source 3 is an LED unit or a tungsten filament. The over coat layer 11 and the coarse surface 12 can be configured at an outer surface or an inner surface of the shell 1. The over coat layer 11 can be gold plating layer, a silver plating layer, or a layer of any other reflective material. The over coat layer 11 is configured extending over at least a half of the area of the shell 1 at a lateral side as shown in FIG. 3 or a bottom of the shell 1 as shown in FIG. 1. The over coat layer 11 is configured as a foggy surface allowing the light to be transmitted therethrough. The coarse surface 12 is processed by an etching process with chemical agents, such as hydrofluoric acid, or ammonia-hydrogen fluoride.

When the cap 2 is assembled into a socket (not shown in the drawings) and provided with a power from the power supply. The light source 3 emits a light illuminating on the shell 1. The coarse surface 12 presents micro-protrusions and micro-recesses. The micro-protrusions and micro-recesses deflect the light to enforce the diffusion of the light passing thereby for achieving an improved illumination performance. Further, the over coat layer 11 reflects the light illuminating thereon towards an opposite side of the over coat layer 11 for achieving an optimal illuminating angle, e.g., about 120°. The coarse surface 12 and the over coat layer 11 configure a foggy appearance on the shell 1. The over coat layer 11 is transparent in part and reflective in part. Therefore, when the light is incident on the over coat layer 11, the reflectivity of the over coat layer 11 does not generate a shadow, so that the light deflected from the coarse surface 12 is more uniformly diffused outwardly.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light bulb, comprising:
a cap;
a light source, secured to and electrically connected to the cap, wherein the cap is adapted for connecting with a power supply for providing an electric current from the power supply to the light source for exciting the light source to emit a light; and
a shell, secured to the cap, and defining a space having an opening, wherein the light source is received in the space of the shell from the opening, and the opening is sealed by the cap, wherein a part of the shell is configured with a coarse surface, and the rest part of the shell is provided with an over coat layer.

2. The light bulb according to claim 1, wherein the light source is an LED unit or a tungsten filament.

3. The light bulb according to claim 1, wherein the over coat layer is made of a reflective material.

4. The light bulb according to claim 1, wherein the over coat layer is formed in a foggy manner allowing a part of the light passing thereby.

5. The light bulb according to claim 1, wherein the over coat layer extends over a bottom of the shell and covers at least a half of the area of the shell.

6. The light bulb according to claim 1, wherein the over coat layer extends over a lateral side of the shell and covers at least a half of the area of the shell.

7. The light bulb according to claim 1, wherein the over coat layer and the coarse surface is provided at an inner surface of the shell.

8. The light bulb according to claim 1, wherein the over coat layer and the coarse surface is provided at an outer surface of the shell.
